(19) United States
(12) Patent Application Publication
(10) Pub. No.: US 2026/0160634 A1
(43) Pub. Date: Jun. 11, 2026

(54) TUBE DETECTION MODULE AND TUBE DETECTION METHOD

(71) Applicant: INDUSTRIAL TECHNOLOGY RESEARCH INSTITUTE, HSINCHU (TW)

(72) Inventors: Pei-Chi KUO, Tainan City (TW); Chin-Jou KUO, Tainan City (TW); Chung-Yuan SU, Tainan City (TW); Bor-Shiun LEE, New Taipei City (TW)

(21) Appl. No.: 19/185,191

(22) Filed: Apr. 21, 2025

(30) Foreign Application Priority Data
Dec. 5, 2024 (TW) 113147311

(51) Int. Cl. G01M 3/24

(52) U.S. Cl. CPC G01M 3/243

(57) ABSTRACT

A tube detection module includes at least two sensing devices disposed outside the tube and an analysis module electrically connected to the at least two sensing devices. Each one of the two sensing devices includes a signal emitter and a signal receiver. The signal emitter and the signal receiver are arranged along an axial direction of the tube. The analysis module is configured to analysis a measurement signal received by the signal receiver to determine the condition of the tube.

### CROSS-REFERENCE TO RELATED APPLICATION

This application claims priority to Taiwan Application Serial Number 113147311, filed Dec. 5, 2024, which is herein incorporated by reference in its entirety.

### BACKGROUND

### Field of Disclosure

The disclosure relates to a tube detection module and tube detection method.

### Description of Related Art

Gas tube is easily affected by environmental factors and the gases transported in the tube, resulting in cracks or structural damage, which in turn cause leaks. Leakage incidents may lead to catastrophic accidents such as fire or explosion, and therefore lead to serious threats to personnel safety and the environment.

In the current tube detection methods, it is impossible to know in advance whether the tube is ruptured or damaged. Therefore, it is impossible to replace the tube in advance to avoid the occurrence of danger, and it can only be repaired after the leak, which increases maintenance costs and risks. In addition, the tube wall thickness detection probe only has single-point measurement and is not easy to detect a larger range. Comprehensive detection requires multiple measurements, which is time-consuming and costly.

### SUMMARY

One aspect of the disclosure is a tube detection module, applied to measure a tube.

In one embodiment, the tube detection module includes at least two sensing devices disposed outside the tube and an analysis module electrically connected to the at least two sensing devices. Each one of the two sensing devices includes a signal emitter and a signal receiver. The signal emitter and the signal receiver are arranged along an axial direction of the tube. The analysis module is configured to analysis a measurement signal received by the signal receiver to determine the condition of the tube.

In one embodiment, the tube detection module further includes a coupling layer disposed between the at least two sensing devices and the tube.

In one embodiment, the at least two sensing devices are fixed on an outer shell of the tube.

In one embodiment, the signal emitter is an ultrasonic element, a knocking element, a vibration element, or a piezoelectric element.

In one embodiment, a number of the at least two sensing devices is two and comprises a first sensing device and a second sensing device. In a cross-sectional view, the first sensing device and the second sensing device are disposed at two opposite sides of the tube and are 180 degrees apart.

In one embodiment, the tube detection module further includes a clamping mechanism detachably clamping the tube, and the first sensing device and the second sensing device are disposed on the clamping mechanism.

In one embodiment, the clamping mechanism further includes a first clamp and a second clamp pin jointing the first clamp, the first clamp has a first wall facing the second clamp, the second clamp has a second wall facing the first clamp, the first sensing device is disposed on the first wall, and the second sensing device is disposed on the second wall.

In one embodiment, the clamping mechanism further includes a knob pin jointing the first clamp and the second clamp.

In one embodiment, a first signal emitter and a first signal receiver of the first sensing device are disposed along a widthwise direction of the clamping mechanism, and a second signal emitter and a second signal receiver of the second sensing device are disposed along the widthwise direction of the clamping mechanism.

In one embodiment, the clamping mechanism further includes a wireless communication module disposed on the first clamp or the second clamp, the wireless communication module is electrically connected to the first sensing device and the second sensing device and is configured to transmit the measurement signal to the analysis module.

Another aspect of the disclosure is a detection method of a tube detection module, applied in a tube detection module.

In one embodiment, the detection method of the tube detection module includes sensing multiple measurement signals by at least two sensing devices disposed outside the tube, each one of the sensing devices includes a signal emitter and a signal receiver, and the signal emitter and the signal receiver are arranged along an axial direction of the tube; and determining the condition of the tube based on the measurement signals measured by the two sensing de.0vices by an analysis module.

In one embodiment, the detection method of the tube detection module further includes sensing a base signal by the at least two sensing devices.

In one embodiment, determining the condition of the tube based on the plurality of measurement signals measured by the at least two sensing device by an analysis module further includes comparing the plurality of measurement signals and the base signal to obtain an amplitude difference.

In one embodiment, determining the condition of the tube based on the plurality of measurement signals measured by the at least two sensing device by an analysis module further includes comparing the plurality of measurement signals and the base signal to obtain a phase shift.

In one embodiment, the detection method of the tube detection module further includes disposing the at least two sensing devices on the tube through a clamping mechanism; and fixing the at least two sensing devices through a knob of the clamping mechanism.

In one embodiment, a number of the at least two sensing devices is two, and disposing the two sensing devices on the tube through the clamping mechanism further includes disposing the two sensing devices at two opposite sides of the tube through the clamping mechanism.

In one embodiment, disposing the two sensing devices on the tube through the clamping mechanism further includes making the two sensing devices 180 degrees apart in a cross-sectional view of the tube.

In one embodiment, the detection method of the tube detection module further includes transmitting the plurality of measurement signals to the analysis module through a wireless communication module disposed on the clamping mechanism.

In the aforementioned embodiments, the tube detection module disclosed in the disclosure is installed on the outer shell of the tube, so that the tube detection can be continuously performed when the tube is in operation, and data collection and computation can be performed in real time. The signal emitter and signal receiver of the sensing device of the tube detection system are spaced apart at a distance, so the condition of a section of the tube can be detected, rather than being limited to the condition of a single detection point. The two sensing devices are respectively arranged at opposite sides of the tube. Such configuration can ensure that the measurement signal received by the signal receiver is sent from the corresponding signal emitter. Therefore, such configuration can improve the detection accuracy within the detection section.

### BRIEF DESCRIPTION OF THE DRAWINGS

FIG. 1 is a schematic diagram of a tube detection module disposed on a tube according to one embodiment of the disclosure.

FIG. 2 is a schematic diagram of a tube detection module disposed on a tube according to one embodiment of the disclosure.

FIG. 3 is a block diagram of the tube detection module.

FIG. 4A is a schematic diagram of a tube detection module disposed on a tube according to another embodiment of the disclosure.

FIG. 4B is a schematic diagram of FIG. 4A from another perspective.

FIG. 5 is a block diagram of the tube detection module in FIG. 4B.

FIG. 6 is a curve diagram of the base signals and measurement signals according to one embodiment of the disclosure.

FIG. 7 is a curve diagram of the base signals and measurement signals according to one embodiment of the disclosure.

### DETAILED DESCRIPTION

Reference will now be made in detail to the embodiments of the invention, examples of which are illustrated in the accompanying drawings. Wherever possible, the same reference numbers are used in the drawings and the description to refer to the same or like parts.

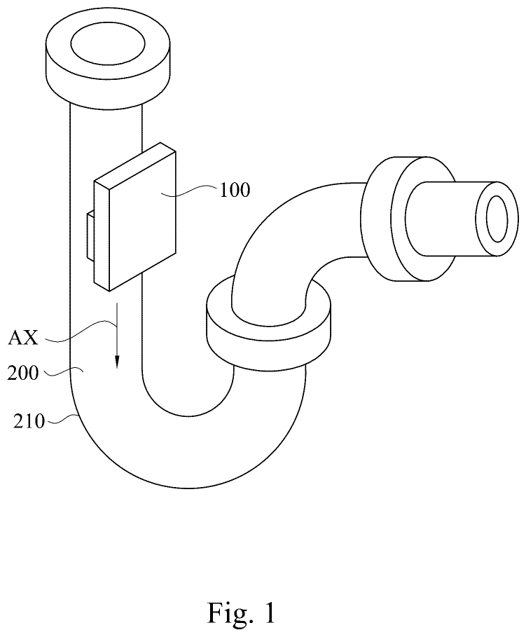

FIG. 1 is a schematic diagram of a tube detection module 100 disposed on a tube 200 according to one embodiment of the disclosure. The tube detection module 100 is installed on the outer shell 210 of the tube 200, so that the tube detection can be continuously performed when the tube 200 is in operation, and data collection and computation can be performed in real time.

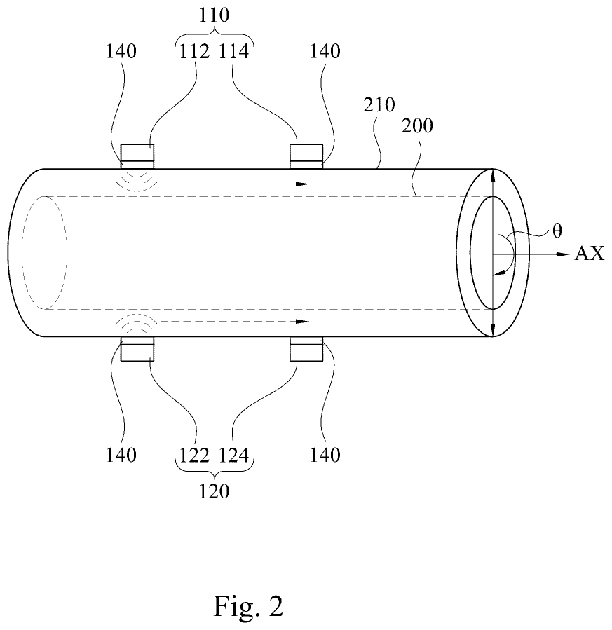

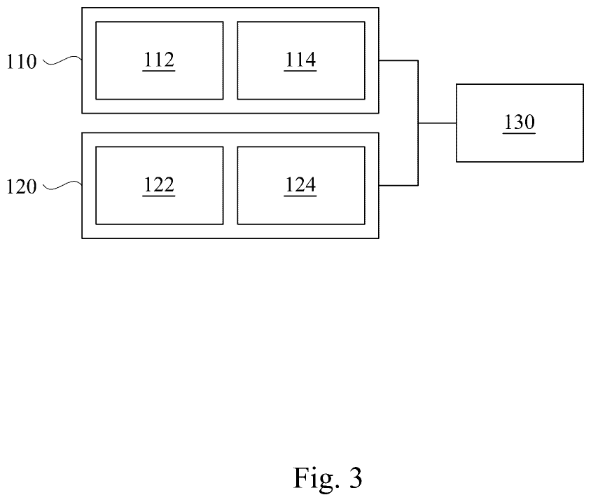

FIG. 2 is a schematic diagram of a tube detection module 100 disposed on a tube 200 according to one embodiment of the disclosure. FIG. 3 is a block diagram of the tube detection module 100. The tube detection module 100 includes at least two sensing devices and an analysis module 130. In the embodiment, the first sensing device 110 and the second sensing device 120 are demonstrated as examples. In other embodiments, the number of sensing devices may be more than two.

The first sensing device 110 includes a first signal emitter 112 and a first signal receiver 114 arranged along the axial direction AX of the tube 200. The first signal emitter 112 and the first signal receiver 114 are spaced apart at a distance. As such, the condition of a section of the tube 200 can be detected, rather than being limited to the condition of a single detection point. The second sensing device 120 also includes a second signal emitter 122 and a second signal receiver 124 arranged along the axial direction AX of the tube 200. The second sensing device 120 has the same technical effect as the first sensing device 110.

The first sensing device 110 and the second sensing device 120 are respectively disposed at two opposite sides of the tube 200. When viewed from a cross-sectional view of the tube 200, the angle θ between the first sensing device 110 and the second sensing device 120 is 180 degrees. Such configuration can ensure that the measurement signal received by the first signal receiver 114 is sent from the first signal emitter 112, and also ensure that the measurement signal received by the second signal receiver 124 is sent from the second signal emitter 122. Therefore, such configuration can improve the detection accuracy within the detected section.

The first signal emitter 112 and the second signal emitter 122 can be ultrasonic elements, a knocking element, a vibration element, or a piezoelectric element. In the embodiment, the first sensing device 110 and the second sensing device 120 are fixed on the outer shell 210 of the tube 200, but the disclosure is not limited thereto.

The analysis module 130 is electrically connected to the first sensing device 110 and the second sensing device 120. The analysis module 130 may be implemented by including a central processing unit (CPU), or other programmable general-purpose or special-purpose microcontroller unit (MCU), microprocessor, digital signal processor (DSP), programmable controller, application specific integrated circuit (ASIC), graphics processing unit (GPU), arithmetic logic unit (ALU), complex programmable logic device (CPLD), field programmable gate array (FPGA) or other similar components or combinations of the above components. The analysis module 130 is configured to analyze the measurement signals received by the first signal receiver 114 and the second signal receiver 124 to determine the condition of the tube 200. The method of determining the condition of the tube 200 will be described in detail in the subsequent tube detection method.

The tube detection module 100 further includes a coupling layer 140. The coupling layer 140 is disposed between the first sensing device 110 and the tube 200, and between the second sensing device 120 and the tube 200. The coupling layer 140 can reduce reflection, increase signal conductivity, and improve signal receiving efficiency.

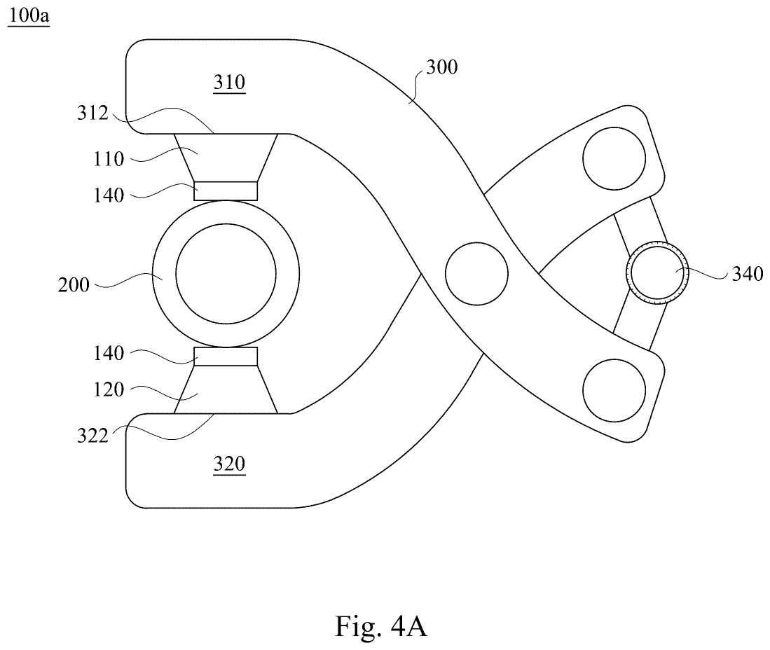

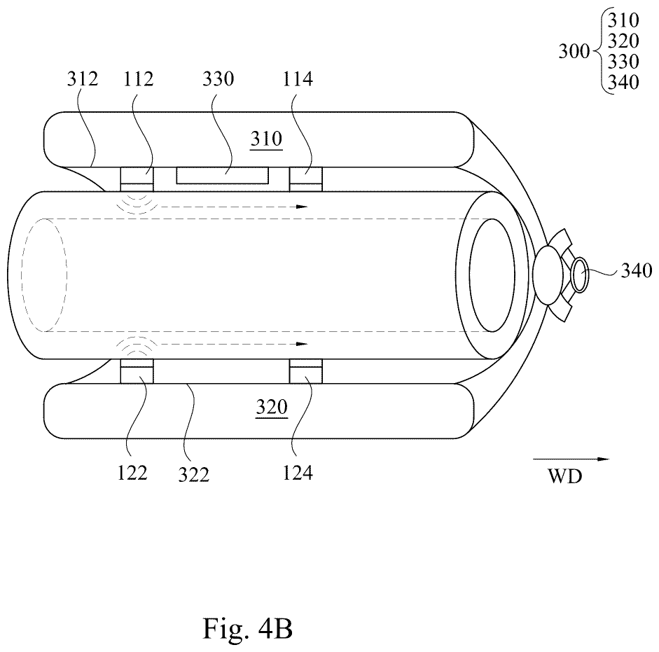

FIG. 4A is a schematic diagram of a tube detection module 100a disposed on a tube 200 according to another embodiment of the disclosure. FIG. 4B is a schematic diagram of FIG. 4A from another perspective. The difference between the tube detection module 100a and the tube detection module 100 in FIG. 2 is that the tube detection module 100a further includes a clamping mechanism 300. The clamping mechanism 300 is detachably clamped on the tube 200 and surrounds the tube 200. The clamping mechanism 300 includes a first clamp 310, a second clamp 320 and a wireless communication module 330. The first clamp 310 has a first wall surface 312 facing the second clamp 320, and the second clamp 320 has a second wall surface 322 facing the first clamp 310. The first sensing device 110 is fixed on the first wall surface 312 of the first clamp 310, and the second sensing device 120 is fixed on the second wall surface 322 of the second clamp 320. The first sensing device 110 and the second sensing device 120 are located at positions of the clamping mechanism 300 facing the tube 200. The clamping mechanism 300 further includes a knob 340 that can enable the first clamp 310 and the second clamp 320 to tightly clamp the tube 200, so that the first sensing device 110 and the second sensing device 120 are closely fixed to the tube 200.

As shown in FIG. 4B, the first signal emitter 112 and the first signal receiver 114 of the first sensing device 110 are disposed along the widthwise direction WD of the clamping mechanism 300 and are spaced apart at a distance. The second signal emitter 122 and the second signal receiver 124 of the second sensing device 120 are disposed along the widthwise direction WD of the clamping mechanism 300 and are spaced apart at a distance. In the embodiment, the widthwise direction WD of the clamping mechanism 300 is substantially parallel to the axial direction AX. The first clamp 310 and the second clamp 320 are symmetrically disposed and are respectively clamped at two opposite sides of the tube 200. In other words, when viewed from the cross-sectional view of the tube 200, the clamping mechanism 300 can enable the first sensing device 110 and the second sensing device 120 to be disposed outside the tube 200 at an angle of 180 degrees relative to each other.

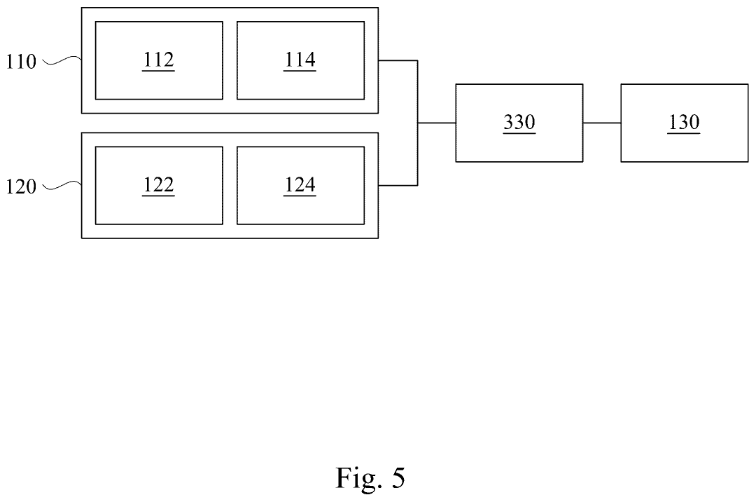

FIG. 5 is a block diagram of the tube detection module 100a of FIG. 4B. Reference is made to FIG. 4B and FIG. 5 simultaneously. The wireless communication module 330 is disposed on the first clamp 310 or the second clamp 320, and is electrically connected to the first sensing device 110 and the second sensing device 120. The wireless communication module 330 is configured to wirelessly transmit the measurement signals received by the first signal receiver 114 and the second signal receiver 124 to the analysis module 130.

The coupling layer 140 of the tube detection module 100a is disposed between the first sensing device 110 and the tube 200 and between the second sensing device 120 and the tube 200.

It should be understood that the connection relationship, materials and advantages of the components that have been described will not be repeated. In the following description, a tube detection method applied to the tube detection modules 100,100a will be described.

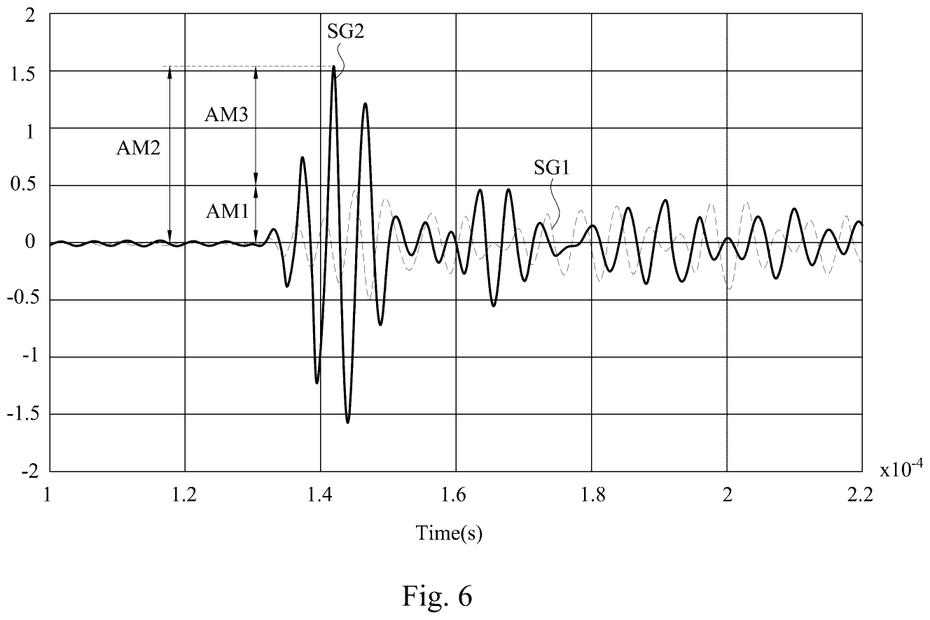

Reference is made to FIG. 2 and FIG. 6. FIG. 6 is a curve diagram of the base signals and measurement signals according to one embodiment of the disclosure. Taking the tube detection module 100 as an example, the tube detection method first starts with detecting the base signal SG1 by the first sensing device 110 and the second sensing device 120. The base signal SG1 is used as a reference signal when the tube 200 is not damaged or broken.

The tube detection method continues by detecting multiple measurement signals SG2 by the first sensing device 110 and the second sensing device 120 disposed outside the tube 200. In this step, the measurement signal SG2 is collected regularly by the first signal receiver 114 and the second signal receiver 124. The base signal SG1 and the measurement signal SG2 may be voltage signals or current signals, but the disclosure is not limited thereto.

Reference is made to FIG. 6. The tube detection method continues by comparing the measurement signal SG2 and the base signal SG1. In some embodiments, an amplitude difference is obtained by comparing the measurement signal SG2 and the base signal SG1. As shown in the figure, the base signal SG1 measured in a specific period has a first amplitude AM1, and the measurement signal SG2 has a second amplitude AM2. An amplitude difference between the base signal SG1 and the measurement signal SG2 is the third amplitude AM3.

The tube detection method continues by determining the condition of the tube 200 based on the measurement signals SG2 measured by the first sensing device 110 and the second sensing device 120 by the analysis module 130. For example, a damage index is calculated based on the measurement signals SG2 and compared with a preset threshold to serve as a basis for determining whether the tube 200 is damaged. When the damage index (DI) is greater than the threshold, the tube 200 is automatically determined as ruptured or damaged.

In one embodiment, the equation of the damage index is

$$DI = \frac{{\int }_{ts}^{tf} {( S ( t ) - {S}_{b} ( t ) )}^{2} dt}{{\int }_{ts}^{tf} {S}^{2} ( t ) dt} ,$$

the S represents the measurement signal, the S_{b} represents the base signal, and tₛ and tᵣ represent start time and finish time respectively.

For example, the first amplitude AM1 of the base signal SG1 in FIG. 6 at about 1.4 seconds is 7 millivolts, and the second amplitude AM2 of the measurement signal SG2 at about 1.4 seconds is 14.2 millivolts. Therefore, the third amplitude AM3 is 7.2 millivolts. According to the third amplitude AM3, the tube 200 can be determined as ruptured or damaged.

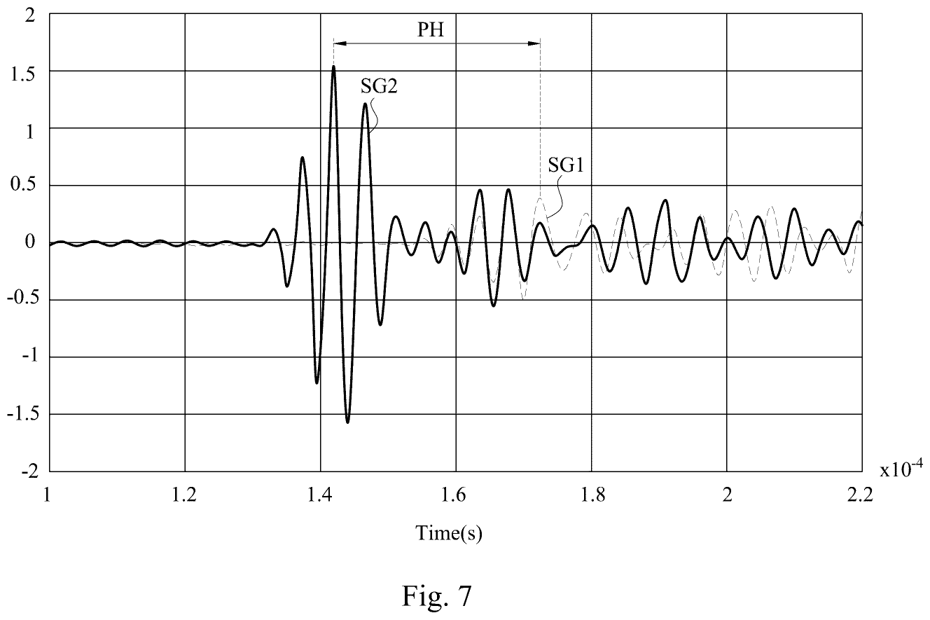

FIG. 7 is a curve diagram of the base signals and measurement signals according to one embodiment of the disclosure. In the embodiment, the measurement signal SG2 is compared with the base signal SG1 to obtain the phase shift PH. Likewise, when the phase shift PH in FIG. 7 exceeds a preset threshold, the tube 200 is automatically determined as ruptured or damaged.

In the embodiment, the base signals SG1 respectively collected by the first sensing device 110 and the second sensing device 120 can be determined by the relative position relationship between the first sensing device 110 and the second sensing device 120. Therefore, from the characteristics of the measurement signal SG2, it can also be known whether the measurement signal SG2 comes from the corresponding signal emitter. For example, if the second signal receiver 124 receives a signal sent from the first signal emitter 112, the amplitude and peak position of this signal will be significantly different from those of the signal sent from the second signal emitter 122.

Accordingly, in other embodiments, the tube detection module can use more than two sets of sensing devices. By disposing the emitter and receiver at a certain distance and measuring the base signal, the detection accuracy within the detected section can be improved.

In another embodiment of a tube detection method, the tube detection module 100a shown in FIG. 4A, FIG. 4B and FIG. 5 is applied. The tube detection method begins by disposing the first sensing device 110 and the second sensing device 120 on the tube 200 by the clamping mechanism 300. Then, the first sensing device 110 and the second sensing device 120 are disposed at opposite sides of the tube 200 through the knob 340 of the clamping mechanism 300 so as to be tightly fixed on the tube 200, and the first sensing device 110 and the second sensing device 120 are 180 degrees apart in the cross-sectional view of the tube 200. The measurement signal SG2 received by the first signal receiver 114 and the second signal receiver 124 is transmitted to the analysis module 130 through the wireless communication module 330.

In summary, the tube detection module disclosed in the disclosure is installed on the outer shell of the tube, so that the tube detection can be continuously performed when the tube is in operation, and data collection and computation can be performed in real time. The signal emitter and signal receiver of the sensing device of the tube detection system are spaced apart at a distance, so the condition of a section of the tube can be detected, rather than being limited to the condition of a single detection point. The two sensing devices are respectively arranged at opposite sides of the tube. Such configuration can ensure that the measurement signal received by the signal receiver is sent from the corresponding signal emitter. Therefore, such configuration can improve the detection accuracy within the detection section.

Although the invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the invention without departing from the scope or spirit of the invention. In view of the foregoing, it is intended that the invention covers modifications and variations of this invention provided they fall within the scope of the following claims.

What is claimed is:

1. A tube detection module, applied to measure a tube, and the tube detection module comprises:
at least two sensing devices disposed outside the tube, and each one of the at least two sensing devices comprises:
a signal emitter; and
a signal receiver, wherein the signal emitter and the signal receiver are arranged along an axial direction of the tube; and
an analysis module electrically connected to the at least two sensing devices and configured to analysis a measurement signal received by the signal receiver to determine a condition of the tube.

2. The tube detection module of claim 1, further comprising:
a coupling layer disposed between the at least two sensing devices and the tube.

3. The tube detection module of claim 1, wherein the at least two sensing devices are fixed on an outer shell of the tube.

4. The tube detection module of claim 1, wherein the signal emitter is an ultrasonic element, a knocking element, a vibration element, or a piezoelectric element.

5. The tube detection module of claim 1, wherein a number of the at least two sensing devices is two and comprises a first sensing device and a second sensing device;
wherein in a cross-sectional view, the first sensing device and the second sensing device are disposed at two opposite sides of the tube and are 180 degrees apart.

6. The tube detection module of claim 5, further comprising:
a clamping mechanism detachably clamping the tube, wherein the first sensing device and the second sensing device are disposed on the clamping mechanism.

7. The tube detection module of claim 6, wherein the clamping mechanism further comprises:
a first clamp; and
a second clamp pin jointing the first clamp, wherein the first clamp has a first wall facing the second clamp, the second clamp has a second wall facing the first clamp, the first sensing device is disposed on the first wall, and the second sensing device is disposed on the second wall.

8. The tube detection module of claim 7, wherein the clamping mechanism further comprises:
a knob pin jointing the first clamp and the second clamp.

9. The tube detection module of claim 6, wherein a first signal emitter and a first signal receiver of the first sensing device are disposed along a widthwise direction of the clamping mechanism, and a second signal emitter and a second signal receiver of the second sensing device are disposed along the widthwise direction of the clamping mechanism.

10. The tube detection module of claim 7, wherein the clamping mechanism further comprises:
a wireless communication module disposed on the first clamp or the second clamp, wherein the wireless communication module is electrically connected to the first sensing device and the second sensing device and is configured to transmit the measurement signal to the analysis module.

11. A detection method of a tube detection module, applied in a tube detection module to measure a tube, wherein the detection method of the tube detection module comprises:
sensing a plurality of measurement signals by at least two sensing devices of the tube detection module, wherein the at least two sensing devices are disposed outside the tube, each one of the sensing devices comprises a signal emitter and a signal receiver, and the signal emitter and the signal receiver are arranged along an axial direction of the tube; and
determining a condition of the tube based on the plurality of measurement signals measured by the at least two sensing devices by an analysis module of the tube detection module.

12. The detection method of the tube detection module of claim 11, further comprising:
sensing a base signal by the at least two sensing devices.

13. The detection method of the tube detection module of claim 12, wherein determining the condition of the tube based on the plurality of measurement signals measured by the at least two sensing devices by the analysis module further comprising:
comparing the plurality of measurement signals and the base signal to obtain an amplitude difference.

14. The detection method of the tube detection module of claim 12, wherein determining the condition of the tube based on the plurality of measurement signals measured by the at least two sensing devices by the analysis module further comprising:
comparing the plurality of measurement signals and the base signal to obtain a phase shift.

15. The detection method of the tube detection module of claim 11, further comprising:
disposing the at least two sensing devices on the tube through a clamping mechanism of the tube detection module; and
fixing the at least two sensing devices on the tube through a knob of the clamping mechanism.

16. The detection method of the tube detection module of claim 15, wherein a number of the at least two sensing devices is two, and disposing the two sensing devices on the tube through the clamping mechanism further comprises:
disposing the two sensing devices at two opposite sides of the tube through the clamping mechanism.

17. The detection method of the tube detection module of claim 16, wherein disposing the two sensing devices on the tube through the clamping mechanism further comprises:
making the two sensing devices 180 degrees apart in a cross-sectional view of the tube.

18. The detection method of the tube detection module of claim 15, further comprising:
transmitting the plurality of measurement signals to the analysis module through a wireless communication module of the tube detection module, wherein the wireless communication module is disposed on the clamping mechanism.
